(19) United States
(12) Patent Application Publication
(10) Pub. No.: US 2026/0340343 A1
(43) Pub. Date: Oct. 29, 2026

(54) DETERMINING REGULATION COMPLIANCE OF ARTIFICIAL INTELLIGENCE MODELS

(71) Applicant: International Business Machines Corporation, Armonk, NY (US)

(72) Inventors: Jiacen Xu, Irvine, CA (US); Sunil Manandhar, Rogers, AR (US); Kapil Kumar Singh, CARY, NC (US)

(73) Assignee: International Business Machines Corporation, Armonk, NY (US)

(21) Appl. No.: 19/191,083

(22) Filed: Apr. 28, 2025

(51) Int. Cl. G06N 3/045; G06N 3/096

(52) U.S. Cl. CPC G06N 3/045; G06N 3/096

(57) ABSTRACT

An embodiment includes executing by an extractor machine learning model extracting a requirement dataset wherein the requirement dataset comprises a requirement classification. The embodiment includes determining compliance of the requirement dataset by an evaluated machine learning model comprising chunking a model card of the evaluated machine learning model by a chunking component of the system outputting a set of chunks. The embodiment includes transforming, by a retrieval augment generation component a chunk based on a similarity measure between a vector of the chunk from the set of chunks and the requirement dataset. The embodiment includes executing the specially purposed compliance instruction by the evaluated machine learning model based in part on the chunk causing the evaluated machine learning model to output a compliance metric. The embodiment also includes executing the specially purposed compliance instruction by the evaluated machine learning model based on a benchmark dataset outputting a compliance metric.

### BACKGROUND

The present invention relates generally to machine learning. More particularly, the present invention relates to a method, system, and computer program for Determining Regulation Compliance of Artificial Intelligence Models.

Advances in artificial intelligence (AI), machine learning models such as large language models (LLMs), have stunned the world with their ability to carry on open-ended conversations and solve complex tasks. LLMs are advanced artificial intelligence systems designed to understand, interpret, and generate human-like text. They are a type of deep learning model that have been trained on a wide variety of texts to understand how characters, words, and sentences function together. Deep learning involves the probabilistic analysis of unstructured data, which eventually enables the deep learning model to recognize distinctions between pieces of content without human intervention.

Large language models (LLMs) have seen increasing popularity in daily use, with their widespread adoption by many corporations as virtual assistants, chatbots, predictors, and many more. The growing influence of these technologies raises the need for safeguards and guardrails to ensure that the outputs from LLMs do not mislead or harm users. This is especially true for highly regulated domains such as healthcare, where misleading advice may influence users to commit malpractice unknowingly. Moreover, these models are typically trained on massive large-scale datasets, and if developed without proper governance, they can readily generate outputs that are not only inaccurate but potentially harmful. Therefore, it is crucial to establish safeguards to ensure their responsible use especially in heavily regulated industries, such as healthcare, law, and finance, that deal with critical decision-making.

### SUMMARY

The illustrative embodiments provide for Determining Regulation Compliance of Artificial Intelligence Models. An embodiment includes responsive to receiving a data stream by a communication interface of an extractor machine learning model of a system, executing by the extractor machine learning model extracting a requirement dataset wherein the requirement dataset comprises a requirement classification. The embodiment includes responsive to the requirement classification, determining compliance of the requirement dataset by an evaluated machine learning model, comprising chunking a model card of the evaluated machine learning model by a chunking component of the system outputting a set of chunks. The embodiment includes transforming, by executing a specially purposed code within a retrieval augment generation component a chunk from the set of chunks based on a similarity measure between a vector of the chunk from the set of chunks and the requirement dataset. The embodiment also includes issuing a specially purposed compliance instruction to a compliance interface of the evaluated machine learning model of the system, executing the specially purposed compliance instruction by the evaluated machine learning model based in part on the chunk causing the evaluated machine learning model to output a compliance metric wherein the compliance metric measures compliance of the requirement dataset by the evaluated machine learning model.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of a system of determining regulation compliance of generative AI models in an environment in accordance with an illustrative embodiment;

FIG. 3 depicts a diagram of components of a system for extracting a requirement dataset from a data stream in an environment in accordance with an illustrative embodiment;

FIG. 4 depicts a diagram of components of a system for using a machine learning model component to determine compliance of an evaluated machine learning model, based on its static model card, with a regulation dataset in an environment in accordance with an illustrative embodiment;

FIG. 5 depicts a diagram of components of a system for using a dynamic machine learning model component to determine compliance of an evaluated machine learning model with regulation dataset in an environment in accordance with an illustrative embodiment;

FIG. 6 depicts a flow chart of using a static and a dynamic machine learning model components to determine compliance of an evaluated machine learning model with regulation dataset in an environment in accordance with an illustrative embodiment; and

FIG. 7 depicts a system diagram for determining regulation compliance of artificial intelligence models using a static and a dynamic machine learning model components in an environment in accordance with an illustrative embodiment.

### DETAILED DESCRIPTION

New AI regulations are being introduced around the world. Examples include the European Union (EU) AI act, AI Measures (China). Similarly, at a federal level, United States has introduced SAFE Innovation Framework, whereas at a state level, Colorado recently introduced Colorado AI Act. On the other hand, a wide range of generative AI models are currently available, catering to diverse applications. Even as the number of models increase from over 900,000 today, more and more legal jurisdictions are planning to introduce comprehensive AI legislation. The legislation is complex. For instance, the EU AI Act has 108 pages with 17 pages of annex. AI risk is one of the key parts in legislation. AI risks encompass a wide range of potential negative outcomes associated with the development and deployment of artificial intelligence systems. These risks can be categorized into various areas, including bias, security, privacy, job displacement, and existential threats, among others.

Compliance to AI regulations is a growing challenge for businesses worldwide, as they face an ever-increasing array of AI regulations and standards across various industries and geographies. To further complicate matters, a growing number of Generative AI models for different applications continue to be developed in the recent years. Current benchmarks focus on safety, robustness, hallucination etc. but fail to measure compliance of these benchmarks to the regulations.

Currently there is no way to ensure to determine compliance of a machine learning model in a technically feasible manner, which can protect users and model creators. There is also currently no holistic system that considers people, systems, contexts, and ecosystems. These current limitations make it impossible to provide efficient, cost-effective and self-aware services, to end users. As a result, current efforts in this regard are inefficient and ineffective due to the current inability to determine compliance of a machine learning model.

The present disclosure addresses the deficiencies described above by providing a process (as well as a system, method, machine-readable medium, etc.) that chunks, transforms within a retrieval augment generation component, executes specially purposed instructions and leverages recent advances in machine learning to determine compliance of a machine learning mode to regulations.

The illustrative embodiments provide for Determining Regulation Compliance of Artificial Intelligence Models. As used herein, the term “regulation” may refer to local and/or national level legislation, standards or similar commitments and requirements.

Illustrative embodiments include responsive to receiving a data stream by a communication interface of an extractor machine learning model of a system, executing by the extractor machine learning model extracting a requirement dataset where the requirement dataset comprises a requirement classification.

As used herein, the term “machine learning model” may refer to any computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Machine learning models can learn through training, where data with known outcomes is inputted into the computer model, outputs regarding the data are compared to the known outcomes, and/or the weights of the computer model are autonomously adjusted based on the comparison to replicate the known outcomes.

Illustrative embodiments include responsive to the requirement classification, determining compliance of the requirement dataset by an evaluated machine learning model comprising chunking a model card of the evaluated machine learning model by a chunking component of the system outputting a set of chunks.

As used herein, the term “model card” may refer to a concise document that provides essential information about a trained machine learning model, including its purpose, performance, intended use, limitations, and potential biases, promoting transparency and responsible AI development.

Illustrative embodiments include transforming, by executing a specially purposed code within a retrieval augment generation component a chunk based on a similarity measure between vectors of the set of chunks and the requirement dataset. In some embodiments, where the similarity measure is based on a cosine similarity score between the vectors of the set of chunks and the requirement dataset.

As used herein, the term “retrieval augment generation” may refer to a known technique used to provide custom data to a machine learning model in order to allow the model to answer queries about data on which it was not trained.

Illustrative embodiments include issuing a specially purposed compliance instruction to a compliance interface of the evaluated machine learning model of the system, executing the specially purposed compliance instruction by the evaluated machine learning model based in part on the chunk causing the evaluated machine learning model to output a compliance metric where the compliance metric measures compliance of the requirement dataset by the evaluated machine learning model.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

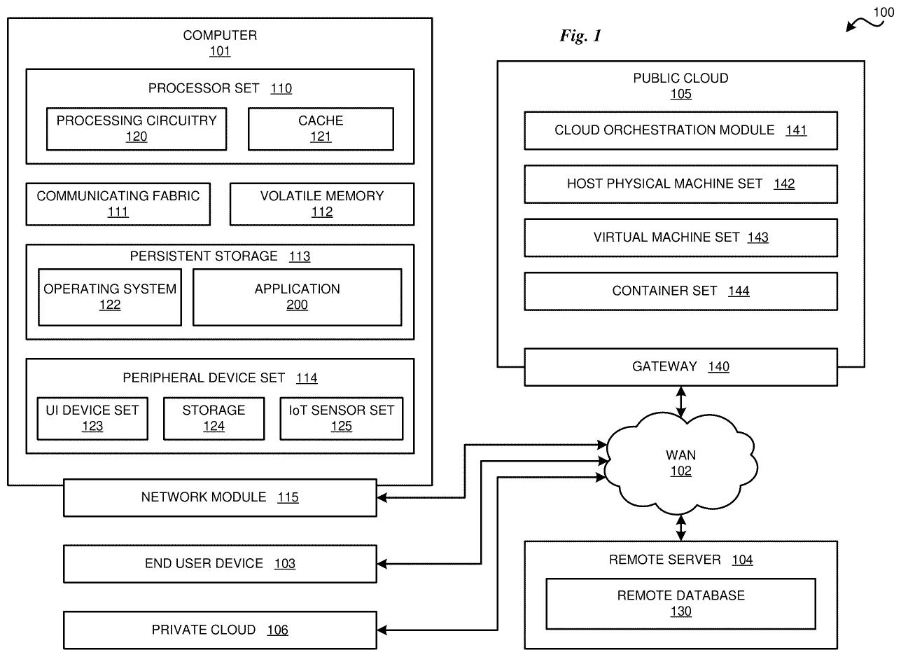

With reference to FIG. 1, this figure depicts a block diagram of a computing environment 100. Data center environment 100 contains an example of an environment for the execution of at least some of the computer code involved in performing the inventive methods, such as an Application 200 that provides Determining Regulation Compliance of Artificial Intelligence Models. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

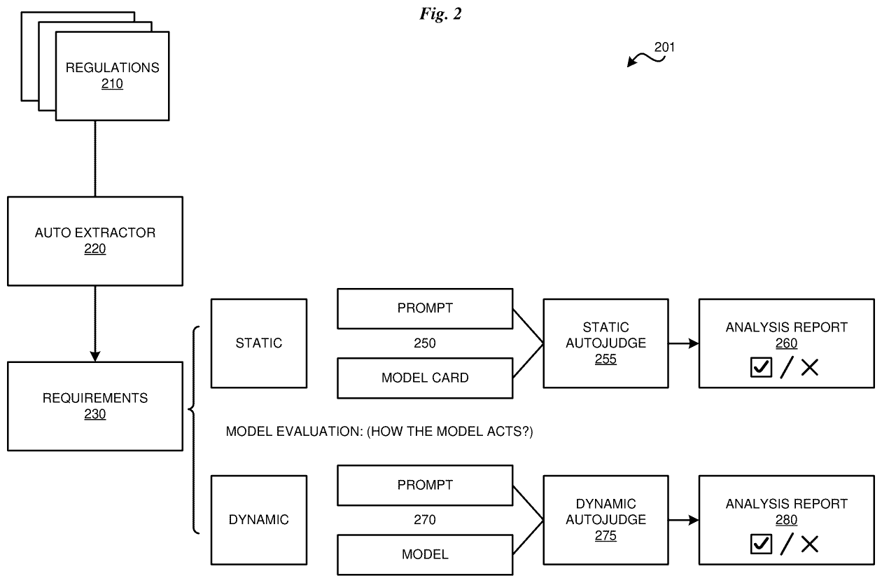

FIG. 2 depicts a diagram of a system of determining regulation compliance of generative AI models in an environment in accordance with an illustrative embodiment. In a particular embodiment, the components of the diagram 201 show aspects of the Application 200 of FIG. 1.

In the illustrated embodiment, a communication interface of an auto-extractor 220 receives data stream of regulations 210. For example, a data stream of regulations may be in formats including but not limited to binary, Extensible Markup Language (XML), and/or structured or unstructured formats according to network communications such as internet protocols.

In some embodiments, an auto-extractor 220 comprises an extractor machine learning model such as a large language model (LLM) with customized prompts. In some examples, the prompts may comprise of a query, a command, or a longer statement including context, instructions, and conversation history. For instance, a prompt may comprise a query “what is the general description of the system, intended purpose, who is the person(s) developing the system, and date and version of the system?”

In embodiments, another LLM may generate a prompt. For example, the automatic prompt engineer algorithm uses one LLM to beam search over prompts for another LLM. There are two LLMs. One is the target LLM, and another is the prompting LLM. A prompting LLM is presented with example input-output pairs, and generates instructions. Each of the generated instructions is used to prompt the target LLM, followed by each of the inputs. The log-probabilities of the outputs are computed and added. This is the score of the instruction. The highest-scored instructions are given to the prompting LLM for further variations. Repeat until some stopping criteria is reached, then output the highest-scored instructions. In other examples, a library of questions is converted to vectors by a model such as Bidirectional Encoder Representations from Transformers (BERT). The question vectors are clustered. Questions nearest to the centroids of each cluster are selected. An LLM does zero-shot chain of thoughts (CoT) on each question. The resulting CoT examples are added to the dataset. When prompted with a new question, CoT examples to the nearest questions can be retrieved and added to the prompt.

In embodiments, an output is a list of requirement dataset 230. In some embodiments, the requirement dataset may comprise verifiable requirements. Regulation expression may be transformed and/or converted from a list to a known format such as JavaScript Object Notation (JSON) using known techniques. The JSON data of name-value pairs and arrays (or other serializable values) may be used as a data exchange with the other components of the system.

In embodiments, responsive to the regulation classification, where the verifiable requirements comprise the regulation classification, the system uses a generated prompt and a model card 250 and a static machine learning model component 255 to determine an analysis report 260 of compliance of an evaluated machine learning model with the regulations. A “model card” in the context of AI and machine learning is a concise document that provides essential information about a trained model, including its purpose, performance, intended use, limitations, and potential biases, promoting transparency and responsible AI development. For example, a model card for the Meta-Llama-3-8B-Instruct may comprise sections on model details, training data, intended use etc.

In another embodiment, responsive to the regulation classification, the system uses a generated prompt and a model 270 and a dynamic machine learning model component 275 to determine an analysis report 280 of compliance of an evaluated machine learning model with the regulations.

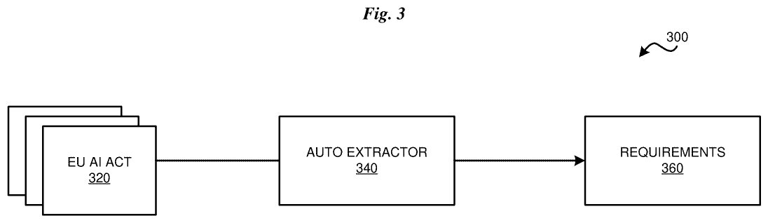

FIG. 3 depicts a diagram of components of a system for extracting a requirement dataset from a data stream in an environment in accordance with an illustrative embodiment. In a particular embodiment, the components of the diagram 300 show aspects of the Application 200 of FIG. 1.

In the illustrated embodiment, responsive to receiving a data stream by a communication interface of an extractor machine learning model of a system, the extractor machine learning model executes to extract a requirement dataset where the requirement dataset comprises a requirement classification. In an example, the data stream may be a data stream of a European Union (EU) AI legislation 320. The data stream may be streamed over a communications channel to a communications interface of an auto-extractor 340, such as an extractor machine learning model, that executes to extract a requirement dataset 360 using known machine learning extraction techniques. For instance, 36 static requirements may be extracted from Annex IV of the EU AI Act.

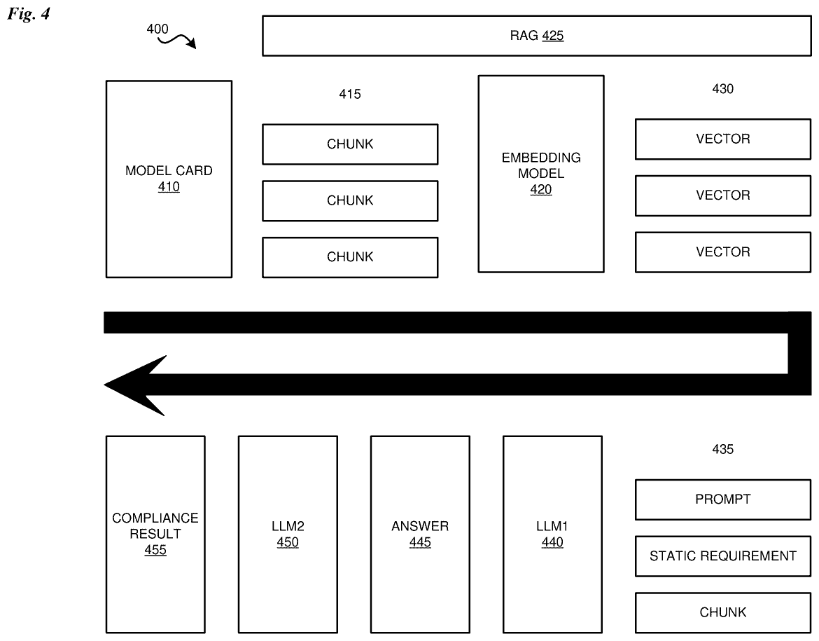

FIG. 4 depicts a diagram of components of a system for using a machine learning model component to determine compliance of an evaluated machine learning model, based on its static model card, with a regulation dataset in an environment in accordance with an illustrative embodiment. In a particular embodiment, the components of the diagram 400 show aspects of the Application 200 of FIG. 1.

In the illustrated embodiment, a model card 410 is chunked 415 and a chunk is inputted into an embedding model 420. For example, the model card is chunked into semantic pieces. For Hugging Face model cards, clues from markdown template can be used to create meaningful chunks. When working with large datasets, such as a model card, chunking improves the computing system including in the areas of memory management such as large texts can overwhelm memory, especially in low-resource environments. Chunking helps break down data into manageable pieces. For instance, chunking improves model efficiency: smaller chunks reduce computational complexity, making it easier for models to process large volumes of data quickly. Chunking improves context management: proper chunking helps retain the context within each segment, which is essential for understanding relationships between parts of the text. Chunking also improves better retrieval and search: chunks make it easier to search for and retrieve specific pieces of information, boosting the accuracy of information retrieval tasks. Smaller chunks can be processed independently, enabling parallelization, which speeds up model training and inference. Chunking also helps with getting accurate answers. For a given question, chunking and RAG help to reduce the search space to the most relevant sections from the model card as opposed to querying the entire document.

In some embodiments, issuing an embedding instruction to a vector interface of an embedding model of the system, executing the embedding instruction by the embedding model causes the embedding model to generate a vector of the chunk. Embedding models are transformer-based neural networks that transform chunks of documents (i.e. passages of text) into a numeric representation or vector. Content with similar meaning or semantics will be mapped to a similar representation in the latent space. After the chunks are converted to vectors 430, the similarity of the independent vectorized passages may be determined by using cosine similarity and/or Euclidean distance. Most embedding models are bi-encoder models. Use a bi-encoder model when high recall is essential, meaning possible matches are not missed, and you need to check the similarity of many passages efficiently.

In another embodiment, by executing a specially purposed code within a retrieval augment generation component (RAG) 425 transforms a chunk based on a similarity measure between vectors of the set of chunks and the requirement dataset. Retrieval augmented generation, or RAG, is a known technique used to provide custom data to a machine learning model in order to allow the model to answer queries about data on which it was not trained. Retrieval-Augmented Generation (RAG) addresses some of the limitations of LLMs by combining them with information retrieval techniques. RAG models enhance the generation process by retrieving relevant documents or passages from a large corpus to provide contextually accurate and up-to-date information. Given a query or prompt, a retrieval module searches a corpus of documents to find the most relevant pieces of information. This is often done using cosine similarity to compare the query vector with document vectors. The retrieved documents are then used to provide additional context to the LLM, which generates the final response. This process helps the model produce more accurate and contextually relevant outputs.

In an embodiment, a specially purposed code within the retrieval augment generation component is executed to transform a chunk and/or chunks most relevant to the static requirement by sorting the chunks based on a similarity measure. For example, the specially purposed code may compare the vector of each chunk in a set of chunks with a vector in the requirement dataset. In such examples, the similarity measure may be a cosine similarity score and/or a Euclidean distance. In an example of Meta-Llama-3-8B-Instruct, chunks from the set of chunks transformed by the RAG component may comprise the following in sorted order:

| | |
|---|---|
| Chunk 1 | Intended Use Cases Llama 3 is intended for |
| | commercial and research use in English. |
| | Instruction tuned models are intended for |
| | assistant-like chat, whereas pretrained |
| | models can be adapted for a variety of natural |
| | language generation tasks. |
| Chunk 2 | Out-of-scope Use in any manner that violates |
| | applicable laws or regulations (including |
| | trade compliance laws). Use in any other way |
| | that is prohibited by the Acceptable Use |
| | Policy and Llama 3 Community License. Use |
| | in languages other than English**. |

In embodiments, a specially purposed compliance instruction is issued to a compliance interface of the evaluated machine learning model of the system. For example, executing the specially purposed compliance instruction by the evaluated machine learning model such as LLM1 440 based in part on the chunk from the RAG component 435, outputs an answer 445 such as a compliance metric where the compliance metric measures compliance of the requirement dataset by the evaluated machine learning model. In some examples, a prompt (designed to retrieve an answer specific to the static requirement) is included in as input to the execution of the specially purposed compliance instruction.

In another example, the answer 445 such as a compliance metric from the execution of the specially purposed compliance instruction by the evaluated machine learning model may comprise:

| | |
|---|---|
| Answer | Yes, the Context does mentions Intended Use |
| | cases. Llama 3 is intended for commercial and |
| | research use in English. Llama 3 is intended for |
| | commercial and research use. |

In some embodiments, a specially purposed scoring instruction is issued to a scoring interface of a scoring machine learning model of the system such as LLM2 450, executing the scoring instruction by the scoring machine learning model causes the scoring machine learning model to output a compliance result 455 as a score based on compliance of the requirement dataset by an evaluated machine learning model. For example, the scoring machine learning model, which may be a classification model, may be trained on the corpus of regulations and comprising the regulation dataset. Executing the specially purposed scoring instruction inputting the compliance metric may return a zero/one, true/false, or similar to indicate compliance of the requirement dataset by the evaluated machine learning model.

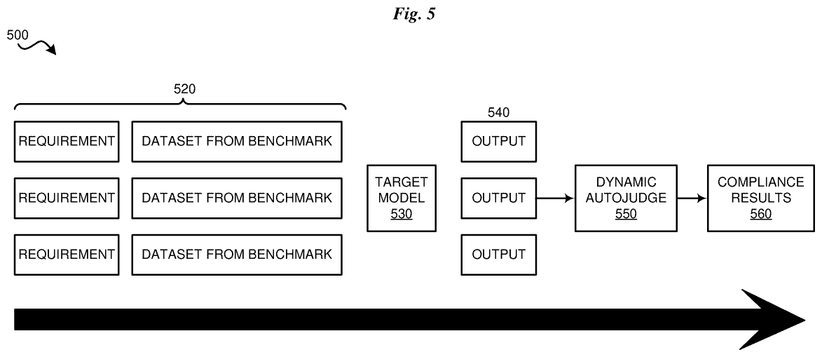

FIG. 5 depicts a diagram of components of a system for using a dynamic machine learning model component to determine compliance of an evaluated machine learning model with regulation dataset in an environment in accordance with an illustrative embodiment. In a particular embodiment, the components of the diagram 500 show aspects of the Application 200 of FIG. 1.

In the illustrated embodiment, a benchmark dataset is derived from the requirement dataset 520. For example, a regulation dataset may comprise regulations from a jurisdiction prohibiting use of AI models in criminal activities. In such examples, a benchmark dataset may comprise of a prompt and/or query to produce an output 540 or a compliance metric from a target model 530, such as an evaluated machine learning model. In an embodiment, a specially purposed compliance instruction is issued to the compliance interface of the evaluated machine learning model of the system, executing the specially purposed compliance instruction by the evaluated machine learning model based on a benchmark dataset, outputs a compliance metric.

In an example, the benchmark dataset may involve phrasing a query, specifying a style, choice of words and grammar, providing relevant context, or describing a character for the AI to mimic. In yet another example, a benchmark dataset may be obtained from sources such as Sorry-bench and Trustllm.

A dynamic auto-judge 550, for example, may be a compliance evaluator machine learning model of the system, issued a specially purposed compliance evaluation instruction to a compliance evaluation interface of a compliance evaluator machine learning model of the system, executing the specially purposed compliance evaluation instruction by the compliance evaluator machine learning model based on the compliance metric causing the compliance evaluator machine learning model to output a compliance result 560. In some examples, the compliance evaluator machine learning model is a classification model. The specially purposed evaluation instruction may comprise of computer instructions fine-tuning the compliance evaluator machine learning model based on the compliance metric and/or the requirement dataset.

Fine-tuning in machine learning is the process of adapting a pre-trained model for specific tasks or use cases. It has become a fundamental deep learning technique, particularly in the training process of foundation models used for generative AI. Fine-tuning could be considered a subset of the broader technique of transfer learning: the practice of leveraging knowledge an existing model has already learned as the starting point for learning new tasks.

In embodiments, the compliance evaluator machine learning model may be fine-tuned by a specially purposed scoring instruction to modify a configuration parameter of the classification model based on the annotations and then checkpointed and benchmarked. This may further comprise issuing a specially purposed finetuning instruction to a finetuning interface of the compliance evaluator machine learning model of the system, executing the finetuning instruction by the compliance evaluator machine learning model causing finetuning of the compliance evaluator machine learning model based on a training dataset. For example, a training dataset may comprise of requirement datasets that are annotated. The benchmark metrics are compared to determine whether to distill an update of the classification model. The classification model executes on each iteration of a new training dataset. If the comparison is below a threshold to indicate that the model performance has declined, a model is distilled based on randomly sampled first k data points from a current production dataset and randomly sampled second k data points from a training dataset associated with the classification model with a previous checkpoint.

In some embodiments, a classification accuracy as well as agreement score between the compliance results and the ground truth is determined by the system. For example, classification accuracy measures the overall correctness of a classification model's predictions by dividing the number of correctly classified instances by the total number of instances. In another example, an agreement score is determined using Cohen's Kappa metric. Cohen's Kappa metric is a statistical measure used to evaluate the agreement between two raters (or classifiers) who each classify items into mutually exclusive categories. It is more informative than simple percent agreement because it also accounts for the agreement that could happen by chance.

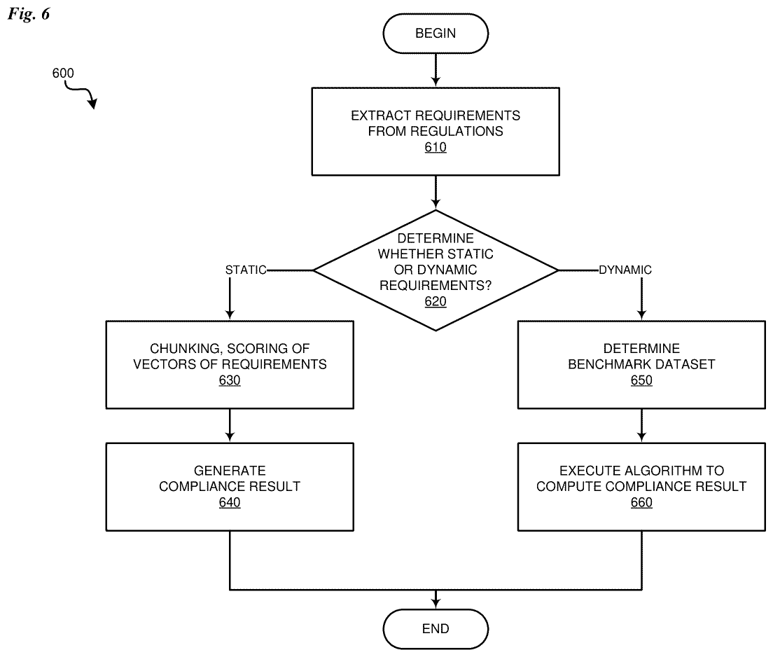

FIG. 6 depicts a flow chart of using machine learning model components to determine compliance of an evaluated machine learning model with regulation dataset in an environment in accordance with an illustrative embodiment. In a particular embodiment, the components of the diagram 600 show aspects of the Application 200 of FIG. 1.

In the illustrated embodiment, the process begins at 610 to extract requirements from regulations. For example, responsive to receiving a data stream by a communication interface of an extractor machine learning model of a system, executing by the extractor machine learning model extracting a requirement dataset wherein the requirement dataset comprises a requirement classification. In some cases, the system determines that the requirement dataset is verifiable, such as, by communicating and performing verification mapping with a third-party verifier.

At step 620, the system determines whether the requirements are static or dynamic. For example, the requirement dataset comprises a requirement classification, and the requirement classification may indicate that a model card exists for an evaluated machine learning model, and therefore the requirements are static. In another example, the requirement classification may indicate that the evaluated machine learning model has refused to answer queries on the requirement dataset in the past, and therefore the requirements are dynamic. In yet another example, after the system has determined a compliance metric as described herein using either static or dynamic requirements, a subsequent determination may be chosen based on the compliance metric. For instance, a static determination may subsequently be a dynamic determination, or a dynamic determination may subsequently be a static determination, or a dynamic determination may subsequently be another dynamic determination. These examples are for illustrative purposes only and use of these examples are not intended to be limiting.

At step 630, responsive to the requirement classification and determining a static requirement, the system chunks and scores vectors of requirements. In an embodiment, a model card is chunked and inputting a chunk into an embedding model. After the chunks are converted to vectors, the similarity of the independent vectorized passages may be determined by using mathematical functions, such as cosine similarity and/or Euclidean distance. In another embodiment, a specially purposed code is executed within a RAG component transforming a set of chunks based on a similarity measure between vectors of the set of chunks and the requirement dataset.

At step 640, the system generates a compliance result. In embodiments, a specially purposed compliance instruction is issued to a compliance interface of the evaluated machine learning model of the system executing the specially purposed compliance instruction by the evaluated machine learning model based in part on the chunk from the RAG component, outputs a compliance metric where the compliance metric measures compliance of the requirement dataset by the evaluated machine learning model.

At step 650, responsive to the requirement classification and determining a dynamic requirement, determine a benchmark dataset. In some embodiments, a benchmark dataset is derived from the requirement dataset.

At step 660, the system executes an algorithm to compute a compliance result. In an embodiment, a specially purposed compliance instruction is issued to a compliance interface of the evaluated machine learning model of the system, executing the specially purposed compliance instruction by the evaluated machine learning model based on a benchmark dataset outputs a compliance metric. A specially purposed compliance evaluation instruction is issued to a compliance evaluation interface of a compliance evaluator machine learning model of the system, executing the specially purposed compliance evaluation instruction by the compliance evaluator machine learning model based on the compliance metric causes the compliance evaluator machine learning model to output a compliance result.

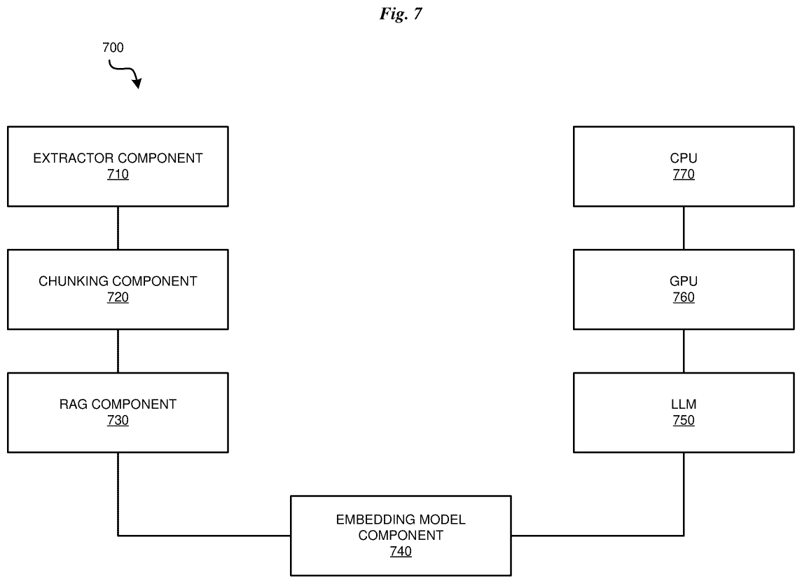

FIG. 7 depicts a system diagram for determining regulation compliance of artificial intelligence models using a static and a dynamic machine learning model components in an environment in accordance with an illustrative embodiment. In a particular embodiment, the components of the diagram 700 show aspects of the Application 200 of FIG. 1.

In the illustrated embodiment, the system may comprise an extractor component 710, a chunking component 720, a RAG component 730, an embedding model component 740, a Large Language Model (LLM) 750, a data store, a general processing unit (GPU) 760, and a central processing unit (CPU) 770. The LLM 750 may comprise a neural network with an encoder-decoder architecture accepting input feature vectors to the machine learning model to perform predictions. The LLM 750 may further comprise a model training interface, an output interface, and a fine-tuning interface. GPU 760 due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

The system may comprise a communication component for receiving a data stream or receiving instructions that interfaces with a network adaptor, a socket, a graphics card, one or more routers, switches, hubs, and/or other network connectivity devices. The communication component may transmit and/or receive data via network links such as data may be transmitted and/or received using Wireless Application Protocol (WAP), Multimedia Messaging Service (MMS), Enhanced Messaging Service (EMS), Short Message Service (SMS), fifth generation (5G), Long Term Evolution (LTE), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

A physical data storage device is the underlying technology behind a data store. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

In some embodiments, the data store stores a persistent attribute of a credential. Database persistence is the process of storing data in a way that allows it to be retrieved later, even after the application that created it has closed. This ensures that data remains accessible, reliable, and intact. Data is written to non-volatile storage, which can retain information long-term. Non-volatile storage can include hard disk drives (HDDs), cloud storage, or other storage devices. Persistent data can be accessed and updated across multiple transactions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
responsive to receiving a data stream by a communication interface of an extractor machine learning model of a system, executing by the extractor machine learning model extracting a requirement dataset wherein the requirement dataset comprises a requirement classification;
responsive to the requirement classification, determining compliance of the requirement dataset by an evaluated machine learning model, comprising:
chunking a model card of the evaluated machine learning model by a chunking component of the system outputting a set of chunks;
transforming, by executing a specially purposed code within a retrieval augment generation component a chunk from the set of chunks based on a similarity measure between a vector of the chunk from the set of chunks and the requirement dataset; and
issuing a specially purposed compliance instruction to a compliance interface of the evaluated machine learning model of the system, executing the specially purposed compliance instruction by the evaluated machine learning model based in part on the chunk causing the evaluated machine learning model to output a compliance metric wherein the compliance metric measures compliance of the requirement dataset by the evaluated machine learning model.

2. The computer-implemented method of claim 1, wherein responsive to the requirement classification, determining compliance of the requirement dataset by the evaluated machine learning model comprising:
issuing the specially purposed compliance instruction to the compliance interface of the evaluated machine learning model of the system, executing the specially purposed compliance instruction by the evaluated machine learning model based on a benchmark dataset outputting a compliance metric; and
issuing a specially purposed compliance evaluation instruction to a compliance evaluation interface of a compliance evaluator machine learning model of the system, executing the specially purposed compliance evaluation instruction by the compliance evaluator machine learning model based on the compliance metric causing the compliance evaluator machine learning model to output a compliance result.

3. The computer-implemented method of claim 1, comprising issuing a specially purposed scoring instruction to a scoring interface of a scoring machine learning model of the system, executing the specially purposed scoring instruction by the scoring machine learning model causing the scoring machine learning model to output a score based on compliance of the requirement dataset by the evaluated machine learning model.

4. The computer-implemented method of claim 2, further comprising issuing a specially purposed finetuning instruction to a finetuning interface of the compliance evaluator machine learning model of the system, executing the specially purposed finetuning instruction by the compliance evaluator machine learning model causing finetuning of the compliance evaluator machine learning model based on a training dataset.

5. The computer-implemented method of claim 1, wherein issuing an embedding instruction to a vector interface of an embedding model of the system, executing the embedding instruction by the embedding model causing the embedding model to generate the vector of the chunk.

6. The computer-implemented method of claim 1, wherein the requirement dataset comprises a verifiable requirement wherein the verifiable requirement is verified by mapping to a regulation.

7. The computer-implemented method of claim 1, wherein the similarity measure is based on a cosine similarity score between the vector of the chunk of the set of chunks and the requirement dataset.

8. A computer program product comprising one or more computer readable storage media, and program instructions collectively stored on the one or more computer readable storage media, the program instructions executable by a processor to cause the processor to perform operations comprising:
responsive to receiving a data stream by a communication interface of an extractor machine learning model of a system, executing by the extractor machine learning model extracting a requirement dataset wherein the requirement dataset comprises a requirement classification;
responsive to the requirement classification, determining compliance of the requirement dataset by an evaluated machine learning model, comprising:
chunking a model card of the evaluated machine learning model by a chunking component of the system outputting a set of chunks;
transforming, by executing a specially purposed code within a retrieval augment generation component a chunk from the set of chunks based on a similarity measure between a vector of the chunk from the set of chunks and the requirement dataset; and
issuing a specially purposed compliance instruction to a compliance interface of the evaluated machine learning model of the system, executing the specially purposed compliance instruction by the evaluated machine learning model based in part on the chunk causing the evaluated machine learning model to output a compliance metric wherein the compliance metric measures compliance of the requirement dataset by the evaluated machine learning model.

9. The computer program product of claim 8, wherein responsive to the requirement classification, determining compliance of the requirement dataset by the evaluated machine learning model comprising:
issuing the specially purposed compliance instruction to the compliance interface of the evaluated machine learning model of the system, executing the specially purposed compliance instruction by the evaluated machine learning model based on a benchmark dataset outputting a compliance metric; and
issuing a specially purposed compliance evaluation instruction to a compliance evaluation interface of a compliance evaluator machine learning model of the system, executing the specially purposed compliance evaluation instruction by the compliance evaluator machine learning model based on the compliance metric causing the compliance evaluator machine learning model to output a compliance result.

10. The computer program product of claim 8, comprising issuing a specially purposed scoring instruction to a scoring interface of a scoring machine learning model of the system, executing the specially purposed scoring instruction by the scoring machine learning model causing the scoring machine learning model to output a score based on compliance of the requirement dataset by the evaluated machine learning model.

11. The computer program product of claim 9, further comprising issuing a specially purposed finetuning instruction to a finetuning interface of the compliance evaluator machine learning model of the system, executing the specially purposed finetuning instruction by the compliance evaluator machine learning model causing finetuning of the compliance evaluator machine learning model based on a training dataset.

12. The computer program product of claim 8, comprising issuing an embedding instruction to a vector interface of an embedding model of the system, executing the embedding instruction by the embedding model causing the embedding model to generate the vector of the chunk.

13. The computer program product of claim 8, wherein the requirement dataset comprises a verifiable requirement wherein the verifiable requirement is verified by mapping to a regulation.

14. The computer program product of claim 8, wherein the similarity measure is based on a cosine similarity score between the vector of the chunk of the set of chunks and the requirement dataset.

15. A computer system comprising a processor and one or more computer readable storage media, and program instructions collectively stored on the one or more computer readable storage media, the program instructions executable by the processor to cause the processor to perform operations comprising:
responsive to receiving a data stream by a communication interface of an extractor machine learning model of a system, executing by the extractor machine learning model extracting a requirement dataset wherein the requirement dataset comprises a requirement classification;
responsive to the requirement classification, determining compliance of the requirement dataset by an evaluated machine learning model, comprising:
chunking a model card of the evaluated machine learning model by a chunking component of the system outputting a set of chunks;
transforming, by executing a specially purposed code within a retrieval augment generation component a chunk from the set of chunks based on a similarity measure between a vector of the chunk from the set of chunks and the requirement dataset; and
issuing a specially purposed compliance instruction to a compliance interface of the evaluated machine learning model of the system, executing the specially purposed compliance instruction by the evaluated machine learning model based in part on the chunk causing the evaluated machine learning model to output a compliance metric wherein the compliance metric measures compliance of the requirement dataset by the evaluated machine learning model.

16. The computer system of claim 15, wherein responsive to the requirement classification, determining compliance of the requirement dataset by the evaluated machine learning model comprising:
issuing the specially purposed compliance instruction to the compliance interface of the evaluated machine learning model of the system, executing the specially purposed compliance instruction by the evaluated machine learning model based on a benchmark dataset outputting a compliance metric; and
issuing a specially purposed compliance evaluation instruction to a compliance evaluation interface of a compliance evaluator machine learning model of the system, executing the specially purposed compliance evaluation instruction by the compliance evaluator machine learning model based on the compliance metric causing the compliance evaluator machine learning model to output a compliance result.

17. The computer system of claim 15, comprising issuing a specially purposed scoring instruction to a scoring interface of a scoring machine learning model of the system, executing the specially purposed scoring instruction by the scoring machine learning model causing the scoring machine learning model to output a score based on compliance of the requirement dataset by the evaluated machine learning model.

18. The computer system of claim 16, further comprising issuing a specially purposed finetuning instruction to a finetuning interface of the compliance evaluator machine learning model of the system, executing the specially purposed finetuning instruction by the compliance evaluator machine learning model causing finetuning of the compliance evaluator machine learning model based on a training dataset.

19. The computer system of claim 15, comprising issuing an embedding instruction to a vector interface of an embedding model of the system, executing the embedding instruction by the embedding model causing the embedding model to generate the vector of the chunk.

20. The computer system of claim 15, wherein the requirement dataset comprises a verifiable requirement wherein the verifiable requirement is verified by mapping to a regulation.
